(19) United States
(12) Patent Application Publication
(10) Pub. No.: US 2004/0216035 A1
(43) Pub. Date: Oct. 28, 2004

(54) TRUSTED PRINTING OF CUSTOMIZED DOCUMENT CONTENT

(76) Inventor: Lotfi BELKHIR, Victor, NY (US)

Correspondence Address: OLIFF & BERRIDGE, PLC., P.O. BOX 19928, ALEXANDRIA, VA, 22320, US

(21) Appl. No.: 10/249,645

(22) Filed: Apr. 28, 2003

(51) Int. Cl. G06F 15/00

(52) U.S. Cl. 715/501.1

(57) ABSTRACT

It is desirable to be able to gather material relating to a desired subject matter, which might stem from different sources or locations, and create one complete document for a consumer. This invention provides systems and methods for selecting at least one content element and selecting at least one, for each selected content element, content portion of that content elements and organizing the content portions into a customized document. This invention provides information regarding the content portion selected by the consumer and provides the customized document to the consumer.

### BACKGROUND OF THE INVENTION

1. Field of Invention

The invention relates to printing customized books.

2. Description of Related Art

When a consumer would like learn about a particular subject, such as the history of the American revolution, bike riding trails in California, or information about traveling in Europe, the consumer will typically go to a store or a website and look for a book or other document relating to that subject.

However, sometimes the book or other document does not quite have all of the topical material desired by the consumer. In this situation, typically the consumer will have to find the additional material in at least one other book or other document. The consumer will then purchase the additional book(s) and/or other document(s) as supplemental material. Ultimately, this situation is more costly and, thus, less desirable to the consumer.

Alternatively, instead of buying additional books and/or other documents, the consumer could pay to have the material added to the book or other document. However, after a book or other document is bound, it is very difficult to change the content of the book or other document other than tearing apart the bound item and adding pages. This procedure is not only time consuming, but costly, and does not usually place the item back in original condition no matter how well the rebinding is performed. Thus, adding supplemental material from a different source to the item, is very difficult, expensive and usually will not be done by the consumer.

Typically, the consumer purchases the supplemental material which may consist of one or more additional books. However, now having the two sources of material, the consumer has to carry both the book/other document and the supplemental material instead of just the one book/other document. Now with two different items to carry, these two items can easily separate and get lost.

Of course, the consumer might not buy either the book/other document or the supplemental material if cost is a priority for the consumer or if the consumer wants to only have one book/other document.

This situation often occurs on college campuses. For example, when teaching a class, most college and university professors rely on more than just one text to cover the entirety of the material they intend to teach. For every class they teach, professors find that while one specific text covers well a specific subject of their class, another subject is better covered by another text. Most professors end up assigning one required reading text for the class and several recommended reading texts to their students as supplemental materials.

However, this puts tremendous strain on the students, who either have to buy all the texts, thus spending large amounts of money and carrying huge loads of items, or have to make an uninformed judgment on which items to buy. Some students, however, will simply go without buying a good number of the items and the information contained therein which is essential for the particular class. University instructors are well aware of this predicament but there is little they can do about it, unless they are willing to compromise the quality of their teaching by sticking to a single text throughout the course.

However, having only a single text covering a specific amount of material will ultimately lead to insufficient material to cover the subject matter of the course and will result in an inferior education for the student. This is a less than ideal situation for the professor, the university, and most importantly, the student.

### SUMMARY OF THE INVENTION

Accordingly, it is desirable to be able to gather material relating to a desired subject matter, which might stem from different sources or locations, and create one complete document for the consumer. Thus, the document will have all the desired subject matter in one customized version, at a lower price, and possibly conveniently bound.

This invention provides systems and methods that allow a consumer to customize document content which can include information from a variety of sources.

This invention separately provides systems and methods that allow a consumer to customize document content by gathering desired subject matter from an unlimited number of sources.

This invention separately provides systems and methods that allow a consumer to select various amounts of material from different works and to compile the selected material as content into one complete customized document for the consumer.

This invention separately provides systems and methods that allow a consumer to choose a variety of physical features of the document to customize a quality of the final document to the consumer's taste.

This invention separately provides systems and methods that provide at least one partial token to a consumer, where each token selected represents a consent portion or a selected quality parameter.

This invention separately provides systems and methods that provide a final composite distribution token to the consumer.

This invention separately provides systems and methods that accept payment from the consumer for the final customized document and that distribute the payment among the various sources of material from whom the consumer chose the content material.

This invention separately provides systems and methods for manufacturing and possibly binding a customized document defined by the consumer.

In the various exemplary embodiments of the systems and methods of this invention, the consumer selects an unlimited number of sources from other books, articles from magazines, journal articles, web site articles, images, other electronic documents and the like which are collated into one final customized document. In various exemplary embodiments, the systems and methods of this invention provide partial tokens containing information about the individual selections made by the consumer. The partial tokens contain information about the content of the textual material, physical features selected, and costs associated with the selections made by the consumer for incorporation into the final customized document. A final distribution token is provided to the consumer that contains information about all of the individual partial tokens as well as the total cost to the consumer. A final customized document is then manufactured for the consumer.

These and other features and advantages of this invention are described in, or are apparent from, the following detailed description of various exemplary embodiments of the systems and methods according to this invention.

### BRIEF DESCRIPTION OF THE DRAWINGS

Various exemplary embodiments of the invention will be described in relation to the following drawings, in which like reference numerals refer to like elements, and wherein:

FIG. 1 is a block diagram of a system for obtaining and paying for content portions to be collected into a final customized content portion;

FIG. 2 is a block diagram of one exemplary embodiment of a consumer customizable content element providing system according to this invention;

FIG. 3 is a flowchart outlining one exemplary embodiment of a method for creating a final customized content element;

FIG. 4 is a flowchart outlining one exemplary embodiment of a method for providing a final customizable content element to a consumer;

FIG. 5 is a flowchart outlining in greater detail one exemplary embodiment of the method for selecting the customizable content element of FIG. 4 according to the invention;

FIG. 6 is a flowchart outlining in greater detail one exemplary embodiment of the method for paying for the consumer customizable content element according to this invention;

FIG. 7 is a flowchart outlining in greater detail one exemplary embodiment of the method for outlining the manufacture of the consumer customizable content element FIG. 4 according to this invention; and

FIG. 8 is a flowchart outlining in greater detail one exemplary embodiment of the method for distributing payment to content portion providers FIG. 4 according to this invention.

### DETAILED DESCRIPTION OF EXEMPLARY EMBODIMENTS

According to various exemplary embodiments of this invention, a consumer will ultimately decide what reading content to incorporate into a final customized document, such as a physical book, an electronic book or e-book, an electronic analog to printed pages, such as a portable document format (PDF) file, or the like. The subject matter content chosen by the consumer will make up the body of the document which the consumer desires to read and is selected from one or more various sources. Once the consumer selects all of the material to incorporate into the final customized document, the material is compiled and all of the selections are formed into the final customized document, which is manufactured for the customer's use. By using various exemplary embodiments of the systems and method according to this invention, the consumer has all of the desired information into one complete document. Additionally, there is no material or content in the document which is not desired by the consumer.

Various exemplary embodiments of the invention can best be understood relating to the situation where a consumer wishes to bring together material from different locations or sources and provide a single document for personal use. Thus, the consumer will choose material from different sources that which will ultimately become one document. However, it should be appreciated that the various exemplary embodiments according to this invention are usable in various other situations, such as the situation discussed above, where a professor selects material to create one text for the professor's students without the need for the students to buy multiple texts, where the created text has all of the desired material, while the other books or other document sources have only a portion of the desired material.

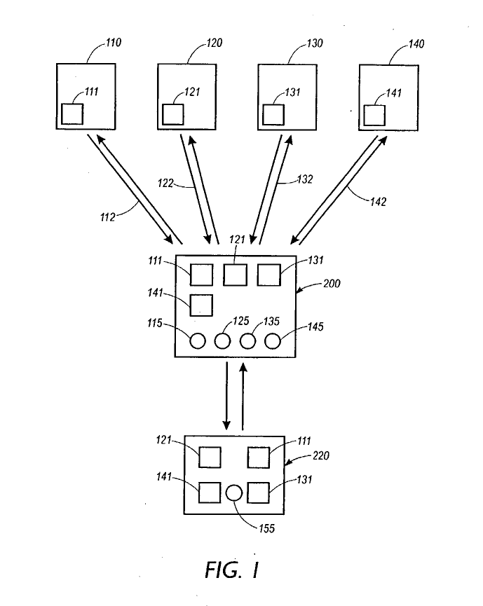

FIG. 1 is a block diagram illustrating one exemplary embodiment of a system usable to obtain content portions for a customizable document, to distribute payment for the obtained content portions and to create the customized document. As shown in FIG. 1, a number of content elements 110, 120, 130 and 140 are sources of content portions that the consumer selects to form the customized document. The content elements 110, 120, 130, and 140 can be any number of sources of material, such as textbooks, magazines, scholarly journals, original material created by the consumer, websites, electronic images, other electronic documents and the like. It should be appreciated that the consumer can select any source of material that contains a content portion the customer desires to be in the customized document. Additionally, other material, such as graphs, drawings, pictures, and the like, which the consumer would like as part of the final customized document, can be added as well. It should be appreciated that the consumer might want to incorporate a whole content element 110, 120, 130, or 140 into the final customized document book.

The consumer can select content elements 110, 120, 130, and 140 by accessing a general provider of information, such as, for example, the Internet or any other known or later developed network, such as a local area network, a wide area network, a storage area network, an intranet, an extranet or the like. The consumer can access this information by using a personal computer, a terminal at a university bookstore, a hand-held computer or device or any other known or later developed method for accessing the Internet or the like. Once on a distributed network such as the Internet, the consumer can search for material from any location of the distributed network to choose the content elements 110, 120, 130, and 140 for the text. Of course, the consumer can utilize search engines that allow the consumer to access electronic links to locations of the distributed network that might provide information concerning the particular topic of interest to the consumer. The consumer can then select the material from any such location for inclusion into the final customized document.

The Internet is only one example of a place for the consumer to gather information. It should be appreciated that the information gathered by the consumer can be provided by any system or apparatus that allows one or more consumers to access information about any number of subjects from one or more locations. For example, the material can be presented in a format allowing the consumer to select that material and at some point later, have that material incorporated into the final customized document.

However, a consumer does not have to choose the whole content elements 110, 120, 130 and 140, to be incorporated into the final customized document.

The consumer can select one or more of the content portions 111, 121, 131, and 141 of the content elements 110, 120, 130 and 140. For example, if the content element 110 is a book, the content portion 111 could be a chapter from the book. Of course, the content portion 111 could also be a page, sentence, or any other amount desired by the consumer. The content portions 111, 121, 131, or 141 can be what ever desired material the consumer would like to select from the content elements 110, 120, 130, and 140.

In various exemplary embodiments of the systems and method according to this invention, after a consumer has chosen the desired content portions 111, 121, 131, and 141 from the selected content elements 110, 120, 130, and 140, the content portions 111, 121, 131, and 141 are brought together into a customized content element 200. The customized content element 200 can be any size the consumer chooses and will continue grow as the consumer chooses more content portions.

Once the consumer has finished selecting the various content portions 111, 121, 131, 141, etc. for the customized content element 200, the consumer can organize the content portions 111, 121, 131, and 141 in any desired manner.

In addition to organizing the final order of how the content portions 111, 121, 131, 141, etc. will appear in the final customized document, the consumer has the additional option of selecting the physical parameters of the final customized document. In various situations, the user may wish the final customized document to be output on hardcopy form, such as a bound or unbound book, a pamphlet, as a loose leaf bound or the like. In various other situations, the user may wish the final customized document to be output as an electronic document stored on a machine-readable medium, such as a CD-ROM, DVD/DVD-ROM, zip disk or other magnetic and/or optically-based storage medium, or any other lotus-developed machine readable storage medium. In various such situations, the user may wish for just page images to be stored, such as in PDF-type format, or may wish for the final customized document to be text-(or image or the like) searchable. The consumer can choose what type of paper the hardcopy document should be printed on or the storage medium for an electronic document, the font(s) used for the portions, whether color or black and white printing is desired, and the like. It should be appreciated that there are endless physical parameters that the consumer to choose from when deciding how the consumer would like the final customized content element to look like.

A final customized content element 220 is the final version of the customized document created by the consumer with all of the content portions 111, 121, 131, and 141 organized in the desired order and all of the physical parameters selected by the consumer incorporated therein.

As discussed above, a consumer can select from a variety of resources and locations for content elements from which to choose content portions to incorporate into the customized content element 200. In various exemplary embodiments of the systems and methods according to this invention, upon selecting the content portions, the consumer will receive a confirmation notification verifying the content portion selected by the consumer. The notification provides the consumer with various amounts of information regarding the selected content portion.

In various exemplary embodiments, the notification is provided to the consumer in the form of a partial token, such as the partial tokens 115, 125, 135 and 145. One or more partial tokens, such as the partial tokens 115, 125, 135 and 145, are provided each time the consumer selects a content portion to be included in the customized content element. The partial tokens 115, 125, 135 and 145 can be an icon on a display screen, an audio or textual message or any other indicator to provide the consumer notice that indicates to the consumer that the consumer has been provided with a particular content portion.

The partial tokens 115, 125, 135 and 145 include a variety of information about what the consumer has selected as a content portion. For example, when the consumer chooses a particular book as a content element and then selects a chapter from a book as the content portion, the consumer is subsequently provided with a partial token for that selection. The partial token will contain information such as the cost of the content portion selected by the consumer that the consumer will be required to pay for incorporating that content portion into the final customized content element. The partial token content portion can also contain information, such as the number of pages or words of the content portion selected, whether any pages have color text and/or images, any author and publishing information of the book, and information such as physical information about the text, such as font information. It should be appreciated that various other pieces of information regarding the selected content portion can be displayed and provided along with the partial token.

Providing the partial tokens 115, 125, 135 and/or 145 to the consumer after the corresponding content portions 111, 121, 131, and/or 141 have been selected allows the consumer to keep track of the selected content portions 111, 121, 131, and/or 141 for the customized content element 220 that is being created. For example, the consumer can track the cost associated with each selected content portion 111, 121, 131 and/or 141 and thus track the total cost of the customized content element 200 as each selection is made. Of course, the consumer can track any other information, such as the current number of pages of the customized content element 200. Thus, the partial tokens can be displayed to the consumer to allow the consumer to recognize what has been selected up to that time.

In various other exemplary embodiments of the systems and methods according to this invention, the consumer can select physical parameters of the final customized document, such as the style of text and/or printing for different portions of the final customized document, the print quality, the paper quality, and/or other types of quality of the pages. Further, the consumer can choose a variety of parameters to incorporate into the electronic document which will create the final version of the document in accordance with the consumer's preference. In such exemplary embodiments, each of the selected physical parameters chosen for the final customized content element 220 will be stored and displayed to the consumer as a partial token. Similar to the partial tokens 115, 125, 135 and 145 provided for the content portions 111, 121, 131, and 141, the partial tokens for the selected physical parameters provide information such as the cost associated with the choice of the particular physical parameter.

As the consumer continues to choose various content portions 111, 121, 131, or 141, and/or continues to (if it is to be output as a hard copy), choose various physical parameters, for the customized content element 200, the consumer continues to receive partial tokens indicating the respective information for such choices. The consumer can also decide whether the consumer would like the final customized content element 220 to be, if it is to be output as a hard copy, hard bound, soft bound or loose leaf bound and the quality of the binding/loose leaf binder. Also, the consumer can select if the consumer would like the book printed at that time, stored for later printing, or printed at a remote location and/or if the hardcopy final customized content element 220 should be shipped to a particular recipient or address, for example, if it is a gift or the like. In addition, the consumer can indicate the quantity of books ordered.

When the consumer has completed selecting the desired content portions 111, 121, 131, or 141 and the desired physical parameters the consumer is then provided with a final composite print token 155. The final composite distribution token 155 incorporates all of the partial tokens generated for the various selections chosen by the consumer into one final token. This final composite distribution token 155 will have information such as the final price, size of the document, the number of chapters and/or the number of pages, the number of copies, as well as the selected physical features. It should be appreciated that the final composite distribution token 155 can provide other information to the consumer.

According to various exemplary embodiments of the systems and methods of this invention, after the consumer has received the final composite distribution token 155, payment is distributed to the content portion providers. First, the partial tokens 115, 125, 135, and 145 are separated into one or more payment channels 112, 122, 132, and 142. The number of payment channels is determined by the number of entities that require payment for providing the selected content portions. Next, the value of the partial tokens 115, 125, 135, and 145 within each payment channel 112, 122, 132, and 142 is determined and payment of the determined amount is directed to that payment channel. Then, in each payment channel, the partial tokens and their associated information and value, are separated. Before final distribution, the payment in each payment channel is divided and allocated to the partial token and the value on the partial token. The payment that was received for each partial token, is then distributed to the content portion providers.

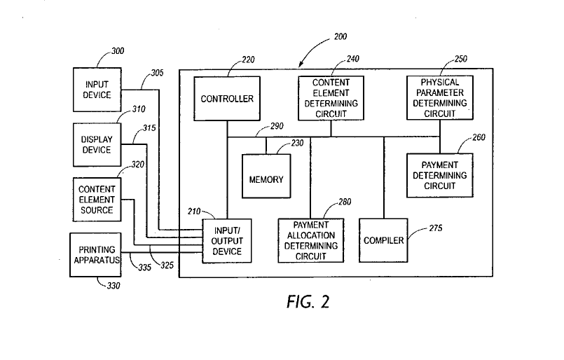

FIG. 2 is a block diagram of one exemplary embodiment of a customizable content system 200 according to this invention. As shown in FIG. 2, the customizable content system 200 includes an input/output device 210, a controller 220, a memory 230, a content element determining circuit 240, a physical perimeter determining circuit 250, a payment determining circuit 260, a compiler 270, and a payment allocation determining circuit 280 payment interconnected by one or more control and/or data buses and/or application programming interfaces 290.

As shown in FIG. 2, a content element source 320 and an input device 300 are connected to the content element system 200 over links 325 and 305, respectively. The content element source 320 can be any source that stores and/or transmits electronic image data. The content element 320 can be connected to the content element system 200 over a connection device, such as a modem, a local area network, a wide area network, an intranet, an extranet, the Internet, any other distributed processing network, or any other known or later developed connection device.

It should also be appreciated that, while the electronic image data can be generated at the time of obtaining an image from an original physical document, the electronic image data could have been generated at any time in the past. Moreover, the electronic image data need not have been generated from an original physical document, but could have been created from scratch electronically. The content element source 320 is thus any known or later developed device which is capable of supplying electronic image data over the link 325 to the content element system 200. The link 325 can thus be any known or later developed system or device for transmitting the electronic image data from the content element source 320 to the content element system 200.

The content element determining circuit 240 determines if the content elements 110, 120, 130 and 140 selected by the consumer are in acceptable format to allow further selection of the content portions 111, 121, 131, 141 to be incorporated into the customized content portion 200. The physical parameter determining circuit 250 determines if the physical parameters chosen by the consumer are compatible with each other and additionally, the content portions 111, 121, 131 and/or 141 previously chosen.

The payment determining circuit 260 determines if the method of payment selected by the consumer is acceptable. If the consumer selects a credit card for payment, the payment determining circuit 260 will determine if the credit card is approved and is authorized for this transaction. If the consumer chooses to pay cash, the payment determining circuit 260 will determine if cash paid is enough to cover the cost of the final customized content element 220.

The payment allocation determining circuit 280 determines how to divide up the payment received from the consumer between the various sources of content elements 110, 120, 130 and 140. The payment allocation determining circuit 280 divides the payment received into the value of each partial token 115, 125, 135, and 145 which is allocated to the respective sources of content portions 110, 120, 130 and 140. Accordingly, the provider of the content elements 110, 120, 130 and 140 is/are paid in accordance with the value of the partial token for each content element. It should be appreciated that each of the providers(s) of the content elements 110, 120, 130 and 140 could be a publishing company, an individual or any other entity responsible for providing one or more of the content elements 110, 120, 130 and 140. Further, if the partial tokens 115, 125, 135, and 145 are earmarked for payment not associated with the provider of the content portions 110, 120, 130 and 140, such as payment for the quality of paper used to print the final customized content element 220 when a hardcopy has been selected, then the payment can be stored in an account for future collection.

In various exemplary embodiments, in operation of the content element system 200, the consumer chooses at least one content element source 320 from which to select a content element portion. Once the content element portion is selected, the input device 300 provides the electronic data of the selected content element portion to the content element system 200 via the input/output device 210. The content element determining circuit 240 determines if the content element is acceptable for selection. After the consumer completes selection of each desired content portion, the chosen content portion is stored in the memory 230.

After a content portion 111, 121, 131 and 141 is chosen and accepted, the consumer is provided a partial token, such as the partial token 115, 125, 135 or 145, containing information about the selected content portion. This partial token, such as the partial token 115, 125, 135 or 145, is displayed to the consumer on the display device 310. Once all of the content portions are selected, or possibly as the content portions are selected, the consumer can arrange the order in which the content portions will appear in the final version of the final customizable document. Additionally, the consumer can choose various physical parameters which will customize taste the final customized content element 220 to the consumers.

Once the consumer has made the selections and the final customized content element 220 is ready for printing, the consumer chooses how to pay. The payment determining circuit 260 makes sure that payment method is acceptable and payment is made in full. The payment is then allocated by the payment allocation determining circuit 280 to the respective sources of content elements base on the value of the partial tokens 115, 125, 135 and/or 145 provided when the various selected content portions were selected by the consumer. The final customized content element 220 is then manufactured or created for the consumer.

A trusted rendering system is used to control the distribution and use of the content portions 111, 121, 131 and 141. According to one exemplary embodiment of the systems and methods according to this invention, the content element system 200 is implemented using a trusted printer. However, the systems and method according to this invention can use any rendering device. A trusted printer facilitates the protection of printed documents which have been printed from a system which controls the distribution of end use of digital works, such as the content portions chosen by a consumer. The system for controlling distribution and use of digital works provides for attaching persistent usage rights to digital works. Digital works are transferred in an encrypted form between repositories. The repositories are used to request and grant access to digital works. Such repositories are also coupled to credit servers which provide for payment of any fees incurred as a result of accessing or using a digital work. A trusted rendering device reduces the risk of unauthorized copying of rendered digital works.

It should be understood that each of the circuits shown in FIG. 2 can be implemented as portions of a suitably programmed general purpose computer. Alternatively, each of the circuits shown in FIG. 2 can be implemented as physically distinct hardware circuits within an ASIC, or using a FPGA, a PDL, a PLA or a PAL, or using discrete logic elements or discrete circuit elements. The particular form each of the circuits shown in FIG. 2 will take is a design choice and will be obvious and predicable to those skilled in the art.

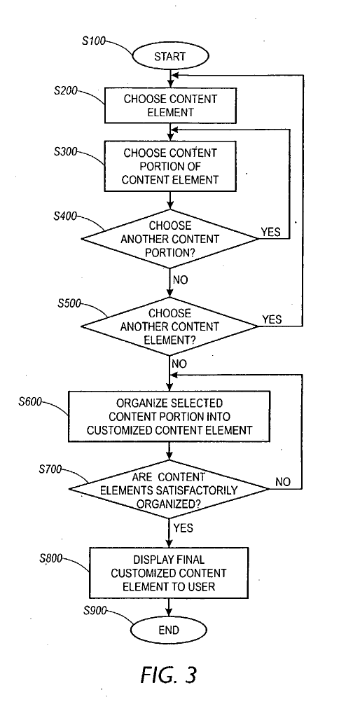

FIG. 3 a flowchart outlining one exemplary embodiment of a method for selecting and organizing content portions by the consumer. As shown in FIG. 3, operation begins in step S100, and proceeds to step S200, where a content element is chosen. Then, in step S300, a content portion of the content element is selected by the consumer. Next, in step S400, a determination is made whether the consumer has chosen another content portion of the selected content element. If another content portion is chosen, operation returns to step S300. Otherwise, operation continues to step S500. In step S500, a determination is made whether the consumer has chosen another content element. If the consumer chooses another content element, operation returns to step S200. Otherwise, operation continues to step S600.

In step S600, the consumer organizes the previously selected content portions into a customized content portion. Next, in step S700, the consumer determines whether the content elements are organized how the consumer would like them to be in their final placement. If the consumer would like to reorganize the content portions, operation returns to step S600. Otherwise, operation continues to step S800, where the final customized content portion as chosen by the consumer is displayed. Operation then continues to step S900, where the method ends. It should also be appreciated, that, in various exemplary embodiments, step S600 can be moved or copies after step S300 and/or step S400.

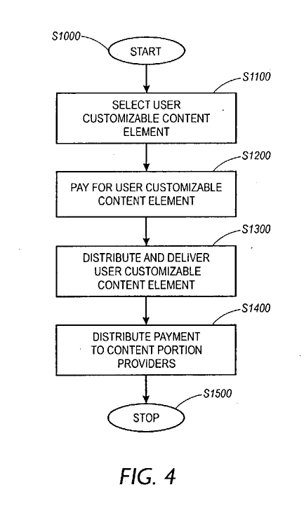

FIG. 4 is a flowchart outlining one exemplary embodiment of a method for designing paying for and providing a consumer customizable content element. Operation begins in step S1000 and proceeds to step S1100, where the consumer designs a customizable content element. In step S1200, the consumer pays for the designed consumer customizable content element. Next, in step S1300, the designed consumer customizable content element is manufactured. Then, in step S1400, the payment received from the customer for the designed consumer customizable content element is distributed to the content portion providers. Operation then continues to step S1500, where the method ends.

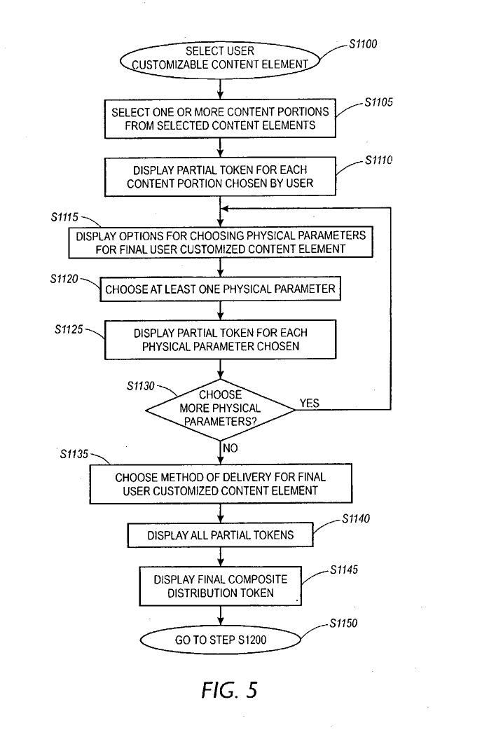

FIG. 5 is a flowchart outlining in greater detail one exemplary embodiment of the method of designing the consumer customizable content elements of step S1100. As shown in FIG. 5, operation begins in step S1100 and continues to step S1105, where the consumer selects one or more content portions from the selected content elements. Next, in step S1110, a partial token is displayed for each content portion selected by the consumer. Then, in step S1115, the options for choosing physical parameters are displayed for the consumer in designing the final customized content element. Operation then continues to step S1120.

In step S1120, the consumer chooses at least one physical parameter. Next in step S1125, the partial token for each physical parameter chosen is displayed for the consumer. Then in step S1130, a determination is made whether the customer wishes to chose more physical parameters for the final customized content element. If more physical parameters are desired by the consumer, then operation returns to step S1115. Otherwise, operation proceeds to step S1135.

In step S1135, the consumer chooses a method of delivery for the final customized content element. Next, in step S1140, all partial tokens are displayed for the consumer. Then, in step S1145, all of the partial tokens are displayed as a final composite distribution token. Operation then continues to step S1150, where operation returns to step S1200.

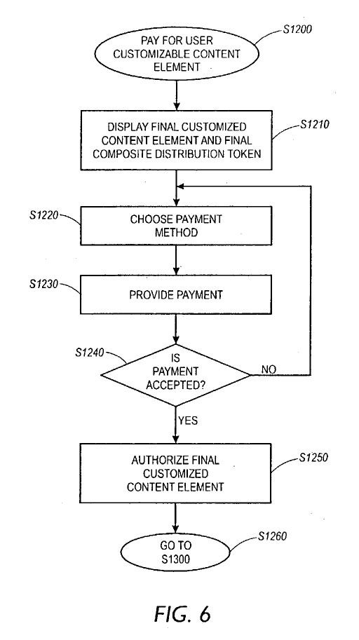

FIG. 6 is a flowchart outlining in greater detail one exemplary embodiment of the method for paying for the designed consumer customizable content element of step S1200. As shown in FIG. 6, operation begins in step S1200, and operation continues to step S1210, where the final customized content element and final composite distribution token are displayed for the consumer. Then, in step S1220, the consumer chooses a method of payment. Next, in step S1230, the consumer provides the payment using the previously selected payment method. Operation then continues to step S1240.

In step S1240, a determination is made whether the payment has been provided and is acceptable. If the payment is not acceptable, then operation returns to step S1220, which allows the consumer to choose an alternative method of payment. Otherwise, operation proceeds to step S1250, where the final customized content element is authorized. Operation then continues to step S1260, which returns operation of the method to step S1300.

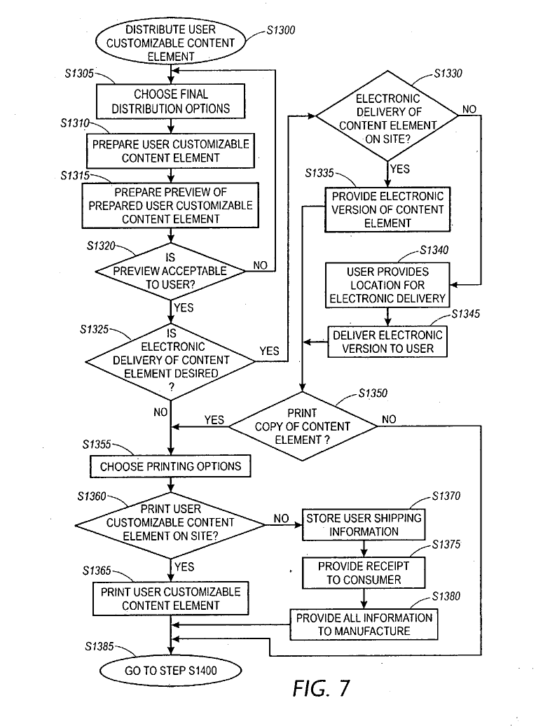

FIG. 7 is a flowchart outlining in greater detail one exemplary embodiment of the method for distributing the designed consumer customizable content element of step S1300. As shown in FIG. 7, operation begins in step S1300, and proceeds to step S1305, where final distribution options are chosen by the consumer. Next, in step S1310, the user customizable content element is prepared. Then, in step S1315, the consumer is shown a preview of the prepared user-customizable content element in order to be approved by the consumer. Next, in step S1320, a determination is made whether the preview is acceptable to the consumer. If the consumer accepts the preview, operation proceeds to step S1325. Otherwise, operation returns to step S1305.

In step S1325, the consumer decides if the consumers wants an electronic delivery of the content element. If the consumer chooses an electronic delivery, then operation proceeds to step 1330, where the consumer decides if the consumer wants the electronic delivery of the content element at the location where the consumer is at the moment, i.e., on-site delivery. If the consumer chooses to have on-site electronic delivery, then operation proceeds to step S1335. Otherwise, operation proceeds to step S1340. In step S1335, the electronic version of the content element is provided to the consumer, by writing the electronic version onto, for example, a floppy disk, a Zip© disk, a CD-ROM, a DVD-ROM or the like. Operation then jumps to step S1350. In contrast, in step S1340, the consumer provides a delivery location such as an e-mail address, a URL or the like, for the electronic version of the content element. Next, in step S1345, the electronic version of the content element is appropriately forwarded to the delivery location provided by the consumer. Operation then proceeds to step S1350. In step S1350, the consumer decides whether the consumer would like, in addition to the electronic version of the content element, a printed hard copy of the content element. If the consumer decides the consumer does not want a printed hard copy of the content element, operation proceeds to step S1385. Otherwise, operation jumps to step S1355. It should be appreciated that the electronic version can be distributed in e-book format, using Adobe's portable document format (pdf), as a WORD® document, or any other usable format. However, based on the digital rights management scheme, if any, used to prevent unauthorized copying or re-distribution of the electronic version, one or more of the available distribution formats may be more appropriate than other such formats.

In step S1355, the consumer chooses among the various manufacturing options. Next, in step S1360, the consumer decides whether the user wants the user-customizable content element prepared at the location where the consumer is at the moment, i.e., on-site or immediate delivery. If the consumer chooses the user-customizable content element to be prepared for on-site delivery, operation proceeds to step S1365. Otherwise, operation jumps to step S1370. In step S1365, the user customizable content element is prepared and delivered to the consumer. Operation then jumps to step S1385. In contrast, in step S1370, the consumer provides the shipping information necessary to have the prepared user customizable content element shipped to a particular location. Next, in step S1375, the consumer is provided with a receipt indicating the various amounts of information regarding the purchase just made by the consumer. Then, in step S1380, all of the necessary information is provided to the manufacturer so that the user customizable content element can be prepared and eventually provided to the consumer. Operation then continues to step S1385, where the operation method returns to step S1400.

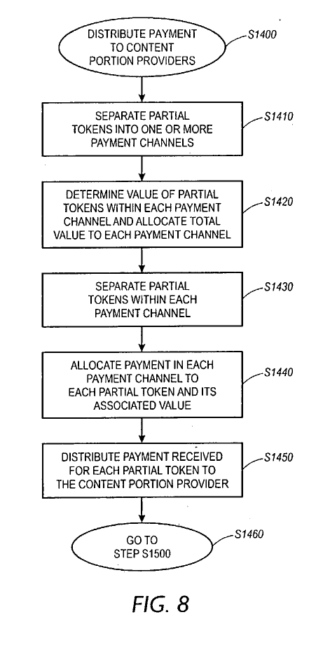

FIG. 8 is a flowchart outlining in greater detail one exemplary embodiment of the method for distributing payment to the content portion providers. As shown in FIG. 8, operation begins in step S1400, and proceeds to step S1410, where the partial tokens are separated into one or more payment channels. Next, in step S1420 the value of the partial tokens within each payment channel is determined and payment of the determined amount is directed to that payment channel. Then, in step S1430, in each payment channel, the partial tokens and their associated information and value, are separated. Operation then continues to step S1440.

In step S1440, the payment in each payment channel is divided and allocated to the partial token and the value on the partial token. Then, in step S1450, the payment that was received for each partial token is then distributed to the content portion providers. Operation then continues to step S1460, where operation of the method returns to step S1500.

While this invention has been described-in conjunction with the exemplary embodiments outlined above, it is evident that many alternatives, modifications and variations will be apparent to those skilled in the art. Accordingly, the exemplary embodiment of the invention, as set forth above, is intended to be illustrative, not limiting. Various changes may be made without departing from the spirit and scope of the invention.

1. A method of creating a customized document, comprising:
selecting at least one content element;
selecting, for each selected content element, at least one content portion of that content element;
receiving, for each selected content portion, information regarding that selected content portion; and
organizing the at least one selected content portion into the customized document.

2. The method of claim 1, wherein at least one of at least one content element is in electronic format.

3. The method of claim 2, wherein at least one of the at least one content element is one of a book, a magazine, a journal or a website article.

4. The method of claim 1, wherein selecting at least one content portion comprises selecting at least a part of a content element.

5. The method of claim 1, wherein selecting at least one content element comprises selecting a non-textual element.

6. The method of claim 5, wherein selecting a non-textual element comprises selecting an image, a graph, a line-art element, a photograph, a bit-map element, or byte map element.

7. The method of claim 1, wherein organizing the at least one content portion comprises organizing the at least one content portion into a final arrangement.

8. The method of claim 1, wherein receiving information regarding a particular content portion comprises receiving at least one partial token indicating information about that content portion.

9. The method of claim 7, wherein the information comprises at least one of at least cost, size and textual information regarding that content portion.

10. The method of claim 9, with further comprising receiving information regarding the at least one partial token.

11. The method of claim 10, wherein receiving information regarding the at least one partial token comprises receiving a final composite distribution token that indicates information regarding the at least one partial token.

12. The method of claim 1, further comprising selecting physical parameters for the customized document.

13. The method of claim 12, wherein the physical parameters are at least one of media type, media size, media quality, font size, text size, color options, copy quantity and distribution options.

14. The method of claim 1, further comprises preparing the customized document.

15. The method of claim 14, wherein preparing the customized document comprises at least one of printing a copy of the customized document and providing an electronic copy of the customized document.

16. The method of claim 15, wherein printing the customized document comprises printing the customized document at at least one of a local location and/or a remote location.

17. The method of claim 15, wherein printing the customized document comprises printing the customized document in at least one of hardback form, unbound form, pamphlet form, and loose-leaf bound form.

18. The method of claim 15, wherein printing the customized document at a remote location comprises receiving shipping instructions.

19. The method of claim 1, further comprising receiving payment for the customized document.

20. The method of claim 19 wherein receiving payment, comprises:
receiving a preferred method of payment; and
approving the preferred method of payment.

21. The method of claim 19, further comprising allocating the received payment to the at least one content element.

22. The method of claim 21, further comprising forwarding the received payment to the content element provider.

23. The method of claim 3, wherein outputting the customized document comprises storing the customized document on an electronic, optical electro-optical, magnetic or magneto-optical medium.

24. The method of claim 23, wherein the output medium is at least one of a CD-ROM, a DVD, a DVD-ROM, a Zip-disk, and a floppy disk.

25. The method of claim 23, wherein storing the customized document on the output medium comprises storing the customized document in a PDF-type format.

26. The method of claim 15, wherein providing an electronic copy of the customized document comprises providing a copy at at least one of a local location and/or a remote location.
